(19) United States
(12) Patent Application Publication
(10) Pub. No.: US 2019/0087817 A1
(43) Pub. Date: Mar. 21, 2019

(54) SYSTEM AND METHOD FOR PERFORMING FINANCIAL TRANSACTIONS USING VIRTUAL SWIPE BANKING

(71) Applicant: Swarna Kumari Adari, Visakhapatnam (IN)

(72) Inventor: Swarna Kumari Adari, Visakhapatnam (IN)

(21) Appl. No.: 15/972,244

(22) Filed: May 7, 2018

(30) Foreign Application Priority Data
Sep. 19, 2017 (IN) 201741033080

(51) Int. Cl. G06Q 20/36; G06Q 20/34; G06Q 20/40; G06F 3/0488

(52) U.S. Cl. CPC G06Q 20/3674; G06F 3/04883; G06Q 20/4012; G06Q 20/351

(57) ABSTRACT

The present disclosure relates to a system and method for performing card less financial transactions by swiping a virtual card on a mobile device in a virtual automated teller machine (ATM) or virtual point of sale (POS) interfaces. In an aspect, the method for generating at least an authentication token to perform at least one physical transaction using an electronic device, includes the steps of swiping virtually, by one or more processors of said electronic device, at least one virtual card selected from one or more virtual cards towards a virtual card slot presented on an interface of the electronic device; and generating, by the one or more processors, said authentication token to perform at least one physical transaction, said at least an authentication token is generated by said electronic device and/or at least by a remote server upon successful authentication.

### FIELD OF DISCLOSURE

The present disclosure relates to a field of banking/financial transactions, and in particular relates to a system and method for performing card less financial transactions by swiping a virtual card on a mobile device in a virtual automated teller machine (ATM) or virtual point of sale (POS) interfaces.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

With limited cash in hand and an indefinite crunch in sight, most people are switching to cash-less transactions. In daily life a user go through a lot of bank cards, which are quite inconvenient to carry the bank card and the problems of losing, damage and the like may be caused due to frequent carrying bank card. Therefore in day to day life the user is often cumbersome to carry a wallet or purse with credit cards, cash cards. Conversely, when the user does not carry bank cards, it is bit inconvenient in an urgent need of money. Therefore there is a need of efficient, effective and reliable financial transaction system and method.

In recent years, financial services industry has become increasingly expanded. Banks, for example, now offer a wide variety of products and services not previously available to customer. Nowadays, financial industries are offering new system such as POS system and ATM system which are combination of hardware and software. However, the process of engaging in cash/cashless transaction using POS at a shopping mall/retail shop, (which may include waiting in line for bill, bill receipt, cash transaction, interacting with the cashier, performing transaction after insertion of card and OTP etc.) is increasingly viewed by financial institution customers as burdensome, time-consuming, and inefficient. On the other hand in the current process of performing financial transaction (which may include insert card, enter PIN, and OTP, and waiting for OTP) at the ATM is also very inconvenient, burdensome and unreliable and inefficient and time consuming process for customer. Irrespective of these drawbacks, additionally, it is often cumbersome to carry ATM cards and keeping ATM cards safe and remembering passwords cause inconvenience in use and raise transaction security issues. However, most people carry a mobile phone or communication device. Therefore, it would be advantageous to provide a way to utilize a mobile phone or communication device to perform financial transaction by virtual swipe of the bank card while avoiding the need for physical swipe of the bank card.

Therefore, it would be advantageous to provide a way in which the conventional method, system and device being replaced or supplemented by quicker, more convenient or more economical financial transaction method by utilizing a virtual swipe in the computing device such as mobile phone by replacement of physical swipe method at the POS and ATM. Further, mobile devices which are very commonly used now days can be used to facilitate a payment transaction, for example, in exchange for a stood or service at a merchant store. A mobile device can be equipped with a near field communication (NFC) system which can be used to transfer the buyer's payment credential, such as credit card information, to a point of sale terminal that is also equipped with a NFC-compatible system to complete the payment transaction.

Therefore, there still exists a dire need to provide a new, technically advanced and improved system and method that enables to perform financial transactions virtually by using mobile devices.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In sonic embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE INVENTION

Some of the objects of the present disclosure, which at least one embodiment herein satisfies are as listed herein below.

It is an object of the present disclosure to provide a system and method that enables for performing financial transaction virtually by using mobile devices.

It is another object of the present disclosure to provide a system and method for performing card less financial transaction by virtual swipe of virtual cards in a virtual automated teller machine (ATM) or virtual point of sale (POS) interfaces.

It is still another object of the present disclosure to provide a system and method for performing financial transaction by virtual swipe of the bank card using a mobile device or an integrated POS monitor.

### SUMMARY

This summary is provided to introduce a selection of concepts in a simplified form to be further described below in the detailed description. This summary is not intended to identity key features or essential features of the claimed subject matter, nor is it intended to be used to limit the scope of the claimed subject matter.

In order to overcome the above problems and to fulfill the expectations of the customers, the objective of the present invention is to provide a new, technically advanced and improved system and method that enables to perform financial transactions virtually by using mobile devices. Embodiments of the present disclosure relates to a system and method for performing card less financial transactions by swiping a virtual card on a mobile device in a virtual automated teller machine (ATM) or virtual point of sale (POS) interfaces.

Embodiment of the present disclosure relates to a field of banking/financial transactions, and in particular relates to a system and method for performing card less financial transactions by swiping a virtual card on a mobile device in a virtual automated teller machine (ATM) or virtual point of sale (POS) interfaces.

An aspect of the present disclosure relates to an electronic device. The electronic device includes a non-transitory storage device having embodied therein one or more routines operable to generate at least an authentication token to perform at least one physical transaction, and one or more processors coupled to the non-transitory storage device and operable to execute the one or more routines.

In an aspect, the one or more routines can include a virtual card swipe module that enables a user to virtually swipe said at least one virtual card selected from said one or more virtual cards towards a virtual card slot presented on an interface of the electronic device, and an authentication token generation module that generates said at least an authentication token to perform at least one physical transaction.

In an aspect, said one or more virtual cards are pre-stored in said non-transitory storage device.

In an aspect, said one or more virtual cards are associated with one or more similar or different financial institution.

In an aspect, said virtual card slot is provided by at least one application program installed on the electronic device or at least by a remote server.

In an aspect, said at least an authentication token is generated by said electronic device and/or at least by a remote server. In another aspect, said authentication token is generated upon successful authentication of said at least one virtual card virtually swiped in said virtual card slot.

In an aspect, said at, least one virtual card swiped virtually in said virtual card slot is authenticated by fetching at least an account detail associated with said at least one virtual card and comparing said account detail fetched with one or more account details pre-stored in said electronic device and/or at least by a remote server.

In an aspect, said at least an authentication token is generated upon providing at least a security number or a personal identification number (PIN) associated with the said at least one virtual card swiped virtually in said virtual card slot. In another aspect, said security number or said personal identification number is authenticated by comparison with one or more account details pre-stored in said electronic device and/or at least by a remote server.

In an aspect, said electronic device is configured to be paired/communicatively coupled with one or more computing devices, wherein said computing devices, upon pairing, are configured to provide said virtual card slot on the interface of said electronic device.

In an aspect, number of authentication tokens can be generated based on details associated with the bank's daily withdrawal or deposit.

In an aspect, one or more cards can be virtually swiped at a time to get the multiple tokens at a time to save lot of time by using multi swiping option.

An aspect of the present disclosure relates to a system a system to generate at least an authentication token to perform at least one physical transaction. The system includes an electronic device that enables a user to virtually swipe said at least one virtual card selected from said one or more virtual cards towards a virtual card slot presented on an interface of the electronic device, and at least one remote server that fetches at least an account detail associated with said at least one virtual card swiped virtually in said virtual card slot, or receives at least a security number or a personal identification number (PIN), and compare said account detail fetched or said security number or said personal identification number with one or more account details pre-stored for generation of said at least an authentication token to perform at least one physical transaction upon authentication.

An aspect of the present disclosure relates to a method for generating at least an authentication token to perform at least one physical transaction using an electronic device. The method includes the steps of swiping virtually, by one or more processors of said electronic device, at least one virtual card selected from one or more virtual cards towards a virtual card slot presented on an interface of the electronic device; and generating, by the one or more processors, said authentication token to perform at least one physical transaction, said at least an authentication token is generated by said electronic device and/or at least by remote server upon successful authentication.

It may be appreciated that, the present disclosure may not only be restricted to withdraw/deposit amount but can do the things whatever physical ATM system provides to the user (based on the bank type) such as PIN change etc.

It may be appreciated that, there is a possibility to get the token number generated still if there is no sufficient funds in the respective account, since if funds can be credited to this account within 30 mins (before expiring the generated token), so users can get the amount from the generated token, however in such scenario, the system may prompt a warning message to the user as “No sufficient funds in the specified card account, do you want to continue to generate the token.”

Various objects, features, aspects and advantages of the present disclosure will become more apparent from the following detailed description of preferred embodiments, along with the accompanying drawing figures in which like numerals represent like features.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1A illustrates a virtual card insertion mechanism at a virtual insertion slot provided for virtual ATM and/or POS and its overall working, in accordance with an exemplary embodiment of the present disclosure.

FIG. 1B illustrates a e-cheque/e-DD insertion mechanism at a virtual insertion slot provided for virtual ATM and/or POS and its overall working, in accordance with an exemplary embodiment of the present disclosure.

FIGS. 2A-2E illustrates virtual transaction operations using the virtual ATM, in accordance with an exemplary embodiment of the present disclosure.

FIG. 3 illustrates a network implementation of virtual transaction system at POS, in accordance with an exemplary embodiment of the present disclosure.

FIGS. 4A-4D illustrates a virtual transaction using swipe with general POS machine, in accordance with an exemplary embodiment of the present disclosure.

FIG. 5A-5F illustrates a virtual transaction using swipe with integrated POS monitor, in accordance with an exemplary embodiment of the present disclosure.

FIG. 6 illustrates a network implementation of a proposed electronic device (also hereinafter interchangeably referred to as “authentication token generator”), in accordance with an exemplary embodiment of the present disclosure

FIG. 7 illustrates exemplary functional modules of the proposed authentication token generator, in accordance with an exemplary embodiment of the present disclosure.

FIG. 8 illustrates an exemplary flow diagram representing method performed by the proposed authentication token generator, in accordance with an exemplary embodiment of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

In the following description, certain terminology is used to describe certain features. The term “mobile device” or “computing device” includes, but is not limited to, a mobile phone, a mobile communication device, personal digital assistant, mobile palm held computer, a wireless device, and/or other types of mobile devices typically carried by individuals and/or having some form of communication capabilities (e.g., wireless, infrared, short-range radio, etc.). The term “customer device”, “customer device” and/or “processing device” may include a mobile device, personal computing device, a digital assistant device, a laptop computer, a point-of-sale device, etc. The term “customer” refers to a person, entity, and/or device that receive the payment from the payer.

An aspect of the present disclosure relates to a system and method for performing card less financial transaction by virtual swipe off virtual bank card (credit card, debit card, ATM card) in a virtual automated teller machine (ATM) or virtual point of sale (POS).

An aspect of the present disclosure relates to a process for performing financial transaction by a virtual swipe of a virtual bank card in a virtual ATM (virtual ATM can be mobile device or computing device) for financial transaction includes the steps of; logging into a mobile/internet banking portal provided a bank server; submitting details such as but not limited to account details, login id or password or customer/user details (including but not limited to customer name, bank name/IFSC code, account number, and mobile number) for logging in; swiping one or more virtual cards (card images) associated with at least one bank towards a virtual card slot (card slot image or card slot image) provided by the bank server; submitting a PIN number associated with the bank card swiped in virtual card slot; entering, upon authentication of the PIN and account details, an amount for which a transaction is to be done (withdrawal or deposit); receiving a token number after entering amount and checking about sufficient funds in respective account; selecting ‘V-swipe banking’ option provided at an interface of a physical ATM machine and submitting the token number received at the ATM; and completing the transaction (withdrawal or deposit) at the physical ATM.

An aspect of the present disclosure relates to a process for performing financial transaction by virtual swipe of the bank card in a virtual POS (virtual POS can be mobile device or portable device) for the POS related financial transaction. The method can include the steps of: logging into a mobile/internet banking portal provided a bank server/service provider; submitting details such as but not limited to account details, login id or password or customer/user details (including but not limited to customer name, bank name/IFSC code, account number, and mobile number) for logging in; swiping one or more virtual cards (card images) associated with at least one bank towards a virtual card slot (card slot image or card slot image) of virtual POS provided by the bank server.

Upon insertion of the virtual card in the virtual card slot, the virtual POS in the mobile device communicates with a physical POS machine. The virtual POS captures all the details from the virtual card and sends to the physical POS machine. The physical POS machine connects with a bank server and validates the card details, and upon the validation and verification of the card details, the POS machine sends instruction to the virtual POS for prompting a PIN. The customer may then enter the PIN from at the virtual POS.

The virtual POS prompts the customer to enter an amount based upon authentication of the PIN entered by the user/customer, and upon entering the amount the virtual POS sends/transmits a request to the physical POS machine to complete the transaction. The bank server upon receiving the details from the physical POS system pays a bill or payment to a merchant based upon authentication/validation of the PIN, and verification about sufficient funds in respective account.

An aspect of the present disclosure relates to a process for performing financial transaction by virtual swipe of the bank card with an integrated POS monitor for POS related financial transaction can include the steps of: swiping the card image to the merchant billing POS monitor; POS monitor connects with bank server and validate the card details. Once the validation and verification is done and succeeded then the POS monitor send instruction to the POS application in the mobile device of a user to enter the PIN. Upon entering the PIN from mobile device the amount is conveyed to the POS monitor and if the if sufficient funds are available then it will approve the billing request and finally print the bill receipt.

In another aspect, a virtual machine such as virtual ATM and virtual POS can execute on a mobile device/portable device. A “virtual machine” is a software implementation or “emulation” of a machine, i.e. a computer, which executes a computer program like a physical machine would. In other words, any program running within the emulated environment runs as if it were being run on the real hardware being emulated. There are several approaches to virtualization. Generally, a software layer provides the virtualization and mediates the sharing of the underlying hardware resources. This software layer could be a virtual machine monitor, supervisory operating system, or a hypervisor. This layer provides a software virtualization environment in which other software, including operating systems, can run with the appearance of full access to the underlying system hardware, but in fact such access is under the complete control of the hypervisor. By using a “hardware abstraction layer,” the hypervisor will handle interrupts from the operating system to the processor, schedule processor time among the guest operating systems and allocate cores to virtual machines, manage devices and allocate memory.

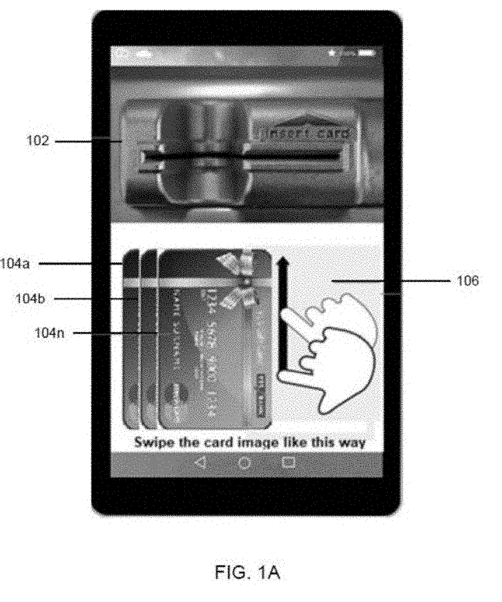

FIG. 1A illustrates a virtual card insertion mechanism at a virtual insertion slot provided for virtual ATM and/or POS and its overall working, in accordance with an exemplary embodiment of the present disclosure. FIG. 1A illustrates a virtual card insertion mechanism at a virtual ATM and its overall working, in accordance with an exemplary embodiment of the present disclosure. FIG. 1A represents interface of a virtual ATM (virtual ATM can be mobile phone or portable device) with a virtual card slot 102, a virtual card 104 and swipe direction 106.

In another aspect, a virtual machine such as virtual ATM and virtual POS can execute on a mobile device/portable device.

In another exemplary embodiment, the “virtual card” refers to an electronic, non-physical representation of a card. A virtual card may be with or without electronic value.

In another exemplary embodiment, a mobile device or portable electronic device can switch among various virtual machines such as virtual ATM and virtual POS machine. In another exemplary embodiment, the mobile device may include hardware, such as, for example, sensors, a display, radios, etc. The mobile device also generally includes a user interface (UI) such as, for example, a touchscreen (which can also serve as the display), a keyboard, a touchpad, etc. The mobile device generally also includes one or more processors, memory and other electrical components.

In an exemplary embodiment, a user interface can be provided that allows the user of the mobile device to select desired operation. For example a virtual card swipe on a touchscreen to the right or left represents the virtual card insertion. In another exemplary embodiment, the user interface can be in a different form in different mobile devices and may be activated in different manners. In another exemplary embodiment, the mobile device can include an input device in order to receive input from the user. The input device can be a keyboard connected to or integrated in the mobile device. Alternatively, the input device can be a touch sensitive screen (touch screen) of the mobile device. The input device can also be an image capturing device (e.g., a camera) or a sound capturing device (e.g., a microphone).

The mobile device is generally capable of accessing a wireless communication network wirelessly in order to perform various functions such as, for example, make phone calls, send messages, access the Internet, etc. The mobile device may comprise any appropriate device for communicating over the wireless communication network. Such devices include mobile telephones, cellular telephones, mobile computers, Personal Digital. Assistants (PDAs), radio frequency devices, handheld computers, laptop computers, tablet computers, palmtops, pagers, integrated devices combining one or more of the preceding devices, and/or the like. The mobile device may communicate with a wireless communication network using one or more standards, including but not limited to, Global System for Mobile Communications (GSM), Internet Protocol (IP) Multimedia Subsystem (IPS or IMS). Time Division Multiple Access (TDMA), Universal Mobile Telecommunications System (UMTS). Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), WiMAX protocols (including Institute of Electrical and Electronics Engineers (IEEE) 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like.

In an embodiment, a representation of ATM card slot 102 which can be used to insert virtual card 104 through swiping towards this card slot image. In an exemplary embodiment, the virtual card 104 can be an image of original debit/credit card captured by the bank while registering for virtual swipe option. The swipe direction 106 can be used to direct the customers on which direction the card image should swipe.

In exemplary embodiment, the virtual card 104 can be image or picture of original debit/credit card/bank card of the customer/user which is captured by the bank while registering for virtual swipe option. In an exemplary embodiment, the virtual card 104 can be captured by the bank while registering for bank account. In an exemplary embodiment, the virtual card can have client's name, CVV/CVC, expiry date and a unique card number printed on it. In another exemplary embodiment, the virtual card can be loaded, installed, and personalized with card specific information, such as account number, name, expiration date, and one or more secure keys. In another exemplary embodiment, the virtual card 104 can be electronic and non-physical card that may include account number or user/customer details. In another exemplary embodiment, the virtual card 104 can be temporary or permanent card that can be system generated based on user request or demand.

In another exemplary embodiment, the virtual card 104 and the virtual card slot 102 can be presented on the display as a virtual wallet and virtual ATM. Further, where the display comprises a touch-sensitive display, a user may be able to make a manual selection from the virtual card by simply touching the desired card.

In another exemplary embodiment, plurality of virtual card can be presented on display and then the user selects the desired card.

One or more virtual cards, each comprising the same or different user information, can be stored in the memory of the mobile device. Each virtual card 104 can be associated with a real-world card. Each virtual card 104 can be associated with one of several terminal devices for enabling an authentication of the user for the specific terminal device. Several virtual cards can be shown on the display device of the mobile device, for example, in the form of a list. A virtual card 104 may be selected via a user input, for example, using an input device of the mobile device. Operations for managing the virtual cards can be provided, for example, a virtual card can be deleted, further information about the virtual card can be displayed, and/or an order of several virtual cards can be adapted.

In one instance, a virtual card 104 can be created, for example, using a scanning device (e.g., a camera) or scanning device of the mobile device. A digital image of a card, such as a plastic card, can be created. The image can be processed, for example, by the processor of the mobile device, in order to obtain user information. The user information can be sent to a server device for further processing, for example, by a processor of the server device. Once the server device has processed the data received, it can transfer back the processed data to the mobile device for confirmation and acceptance purposes. Once these processes are complete, the virtual card can be created and stored in the memory of the mobile device and is available for use.

In an exemplary embodiment, the virtual card slot 102 can be card slot image or card slot representation or virtual card slot representation or electronic or non-physical card slot. In an exemplary embodiment the virtual card slot 102 can be used to swipe a magnetic stripe or magnetic chip or microprocessor associated with the virtual card. In an exemplary embodiment, the virtual card slot 102 can be used to read or scan magnetic stripe or magnetic chip or microprocessor associated with the virtual card.

In an exemplary embodiment, FIG. 1A represents insertion of the virtual card 104 by swiping the virtual card 104 towards the virtual card slot 102. In an exemplary embodiment, FIG. 1 A represents the virtual card swipe direction 106 which is in upward direction. In an exemplary embodiment, the virtual card swipe direction can be represented by 106. In an exemplary embodiment, the virtual card swipe direction 106 can be downward direction in case if the virtual card slot is in bottom side and the virtual card is in top side. It may be appreciated that, the swipe direction is not limited to only upward or downward but in any direction; however, it should be capable of being virtually inserted in said virtual card slot.

FIG. 1B illustrates a e-cheque/e-DD 108 insertion mechanism at a virtual insertion slot 102 provided for virtual ATM and/or POS and its overall working, in accordance with an exemplary embodiment of the present disclosure. In an exemplary embodiment, for performing financial transaction by virtual swiping of e-cheque and/or e-DD in a virtual insertion slot of virtual ATM and/or virtual POS. For performing the process, the user has to virtually swipe the e-cheque and/or e-DD in the virtual insertion slot of the virtual ATM and/or virtual POS. Upon successful insertion, a receipt having a token number along with a machine readable/scannable code associated with the token number and/or transaction is generated. The user can visit the nearest physical ATM or POS machine to clear the e-cheque and/or e-DD using the token number and/or the machine readable/scannable code. In an aspect, the machine readable/scannable code can be a barcode/QR code. In an example, users can also pay their bills using e-cheques and/or e-DD.

In another exemplary embodiment, the user can swipe the e-cheque and/or e-DD in the virtual card slot for clearing by physically not going to ATM or bank.

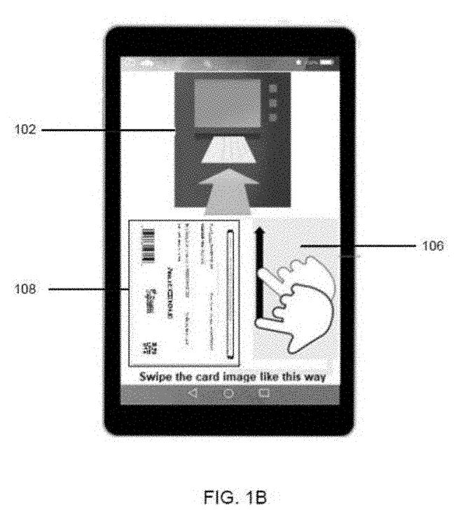

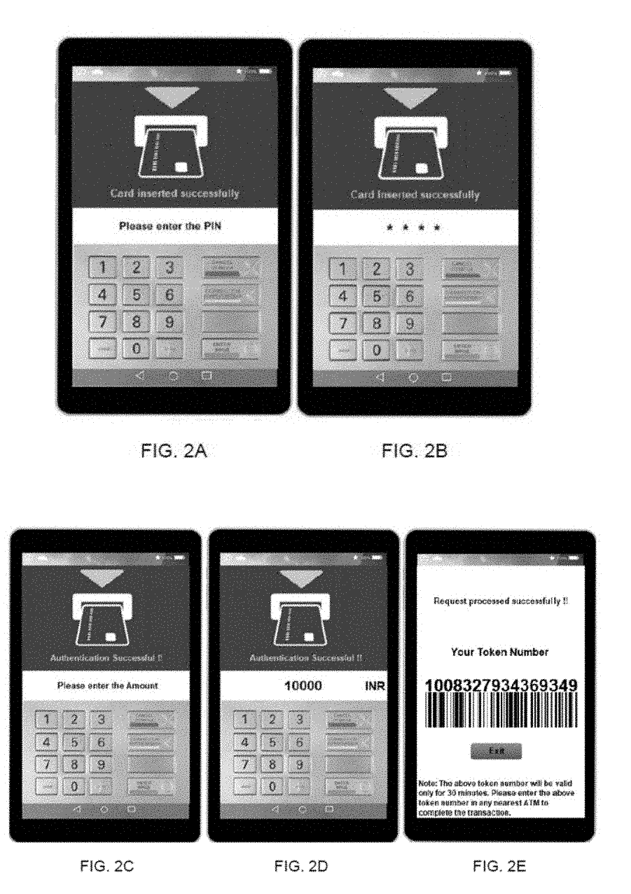

FIGS. 2A-2E illustrates virtual transaction operations using the virtual ATM, in accordance with an exemplary embodiment of the present disclosure. In an exemplary embodiment, the customer/user swipes the card image as described in FIG. 1 and if the card image can swipe correctly and then the virtual card slot 102 color or color representation may be change to green color to represent that the virtual card 104 inserted properly/correctly in the virtual card slot 102. In another exemplary embodiment, the correct or proper insertion of the virtual card 104 can be represented by the notification such as “card inserted successfully” at the interface or display of the virtual ATM (mobile device or portable device) of the customer.

It may be appreciated that, users can also user their biometric scanners on mobile phones to authenticate the card instead of PIN number.

FIG. 2A illustrates an interface/display of the virtual ATM provided on a mobile device to prompt the customer to enter the PIN based upon the accurate insertion of the virtual card 104 into the virtual card slot 102. In an exemplary embodiment, the system can prompt the customer to enter the PIN number based upon the accurate insertion of the virtual card 104 into the virtual card slot 102.

In an exemplary embodiment, mobile device can operate as a virtual machine running within a virtualization platform that is itself running on top of the operating system of personal mobile device.

In an exemplary embodiment, upon successful insertion of the card, the customer can enter the PIN which is pre-defined/pre-configured by the user while bank account opening/with the bank server. FIG. 2B illustrates the interface/display of the virtual ATM which shows the PIN is entered by the user/customer.

In ran exemplary embodiment, the bank server can be used to retrieve the bank card details associated with the user. In another exemplary embodiment, the bank server can store the user/customer details associated with the virtual card. In another exemplary embodiment, the bank server can authenticate/validate the bank card details associated with the user to complete financial transaction. In another exemplary embodiment, the bank server can be a central server that stores personal details associated with at least one bank. In another exemplary embodiment, one or more different bank servers can be coupled/connected with another central bank server.

FIG. 2C illustrates the interface/display of the mobile device to prompt the customer to enter an amount based upon authentication of the PIN and card inserted by the user/customer. In an exemplary embodiment, the system or bank server can validate/verify/authenticate the PIN and account details entered by the user/customer. FIG. 2D illustrates the interface/display which shows the amount entered by the user/customer which user/customer want to withdrawal from the physical ATM.

FIG. 2E illustrates the interface/display of the mobile device with a token number generated after entering amount and upon checking about sufficient funds in respective account. In another exemplary embodiment, the customer can enter the amount which he/she want withdrawal from the ATM and then the system or bank server check about sufficient funds in respective account. In another exemplary embodiment, the system or the bank server can generate/create the token number upon checking sufficient amount or fund in account of the user/customer.

In another exemplary embodiment, the token number can valid only pre-defined/pre-determined/particular time limit such as for 30 minute. In another exemplary embodiment, the token number can be in pre-define/pre-determined formats such as the token number can include a bank code. IFSC code or bank name for instance the token number is 108945523456788 wherein last 5-6 digits can represent the bank code. In another exemplary embodiment, the token code can be validate/authenticated by the bank server. In another exemplary embodiment, the token number can be transmitted to the registered mobile number of the user/customer.

In an exemplary embodiment, once the token number is generated, the customer/user visits to nearest physical ATM and selects the ‘V-swipe banking’ option. The user then enters the Token number which received form bank server. Once the customer enters the Token number it will be validate by the bank server and it process the request and it directly dispense the amount which is requested while requesting through virtual swipe.

In an exemplary embodiment, the Token number consists of a bank code so that the bank server will detect the token belongs to which bank and it process the request accordingly.

In an exemplary embodiment, the generated token number can be similar to OTP which can be expired within 30 mins from the generation. So customers are requested to use this token number within 30 mins in any ATM centre which supports V-swipe V-swipe banking.

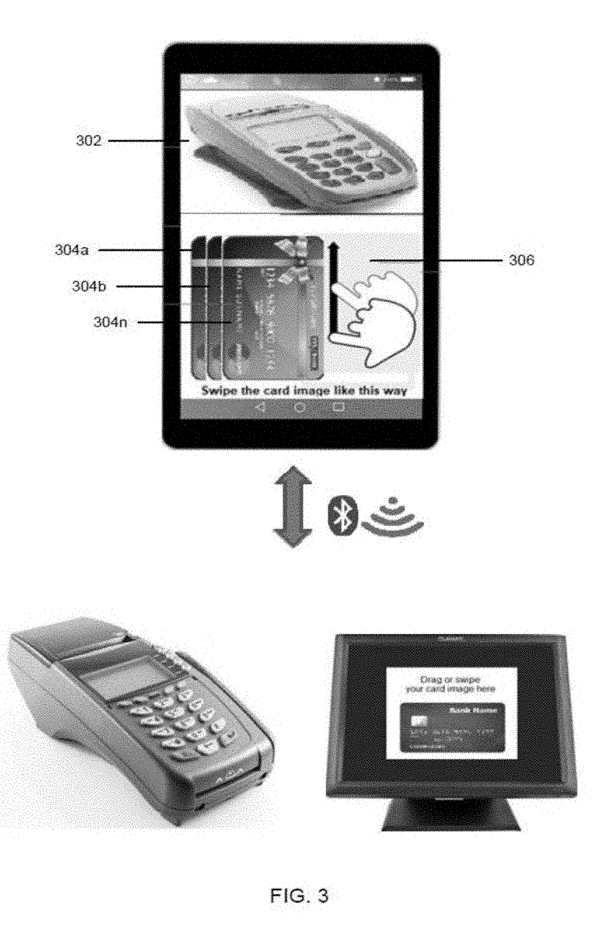

FIG. 3 illustrates a network implementation of virtual transaction system at POS, in accordance with an exemplary embodiment of the present disclosure. In an embodiment, the process for virtual transaction system at POS is different than the ATM is that first the mobile device needs to be paired with the POS machine (at merchant counter) through wireless or wired communication and then user should install and open the generic POS application (which may be specific for respective bank or POS machine). In an embodiment, FIG. 3 illustrates a virtual POS card slot of a virtual POS machine 302, a virtual card 304 and swipe direction 306.

The present disclosure refers to the usage of a mobile device, a terminal device, and a server device. Each device may comprise one or more processors or processing components configured to execute instructions. Further, each device may comprise a memory in form of volatile memory (e.g., RAM—random access memory) and/or non-volatile memory (e.g., a magnetic hard disk, a flash memory). Each device may further comprise means for connecting and/or communicating with other devices, for example, by a wired connection (e.g., LAN—local area network, Firewire (IEEE 1394), and/or USB—universal serial bus) or by a wireless connection (e.g., WLAN—wireless local area network, Bluetooth, near filed communication (NFC) and/or WiMAX—Worldwide Interoperability for Microwave Access). Each device may comprise a device for registering user input, for example, a keyboard, a mouse, and/or a touch pad. Each device may comprise a display device. Alternatively, each device may be connected to a display device. The display device may be a touch-sensitive display device (e.g., a touch screen).

It would be appreciated that the proposed virtual transaction system may be accessed by multiple users (not shown), through one or more computing devices (collectively referred to as computing devices hereinafter), or applications residing on the computing devices. In an aspect, the proposed virtual transaction system can be operatively coupled to a website and so be operable from any Internet enabled computing device. Examples of the computing devices may include, but are not limited to, a portable computer, a personal digital assistant, a handheld device, and a workstation. The computing devices are communicatively coupled to the proposed virtual transaction system through a network.

In one implementation, the network can be a wireless network, a wired network or a combination thereof. The network can be implemented as one of the different types of networks, such as intranet, local area network (LAN), wide area network (WAN), the interact, and the like. Further, the network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 104 can include a variety of network devices, including routers, bridges, servers, computing devices, storage devices, and the like.

In an embodiment, the virtual transaction system (virtual transaction system can be considered as mobile device) can be connected with general/real POS and an integrated POS monitor. In an exemplary embodiment, the virtual transaction system can be connected/paired with the general/real POS machine or the integrated POS monitor through wired or wireless connection such as GSM module or Bluetooth module or WI-FI module. In another exemplary embodiment, the general POS machine can be POS machine or device which is used at all merchant counters and widely used for banking transaction. In another exemplary embodiment, the integrated POS monitor can be screen/monitor or computer or touch screen monitor used for financial transaction and available at all merchant counters.

In an exemplary embodiment, the virtual card 304 can be image or picture of the bank card. In exemplary embodiment, the virtual card 304 can be image or picture of original debit/credit card/bank card of the customer/user which is captured by the bank while registering for virtual swipe option. In an exemplary embodiment, the virtual card 304 can be captured by the bank while registering for bank account. In an exemplary embodiment, the virtual card can have client's name, CVV/CVC, expiry date and a unique card number printed on it.

In an exemplary embodiment, the virtual card slot 302 can be card slot image or card slot representation or virtual card slot representation. In an exemplary embodiment, the virtual card slot 302 can be used to swipe a magnetic stripe or magnetic chip or microprocessor associated with the virtual card. In an exemplary embodiment, the virtual card slot 302 can be used to read or scan magnetic stripe or magnetic chip or microprocessor associated with the virtual card.

In an exemplary embodiment, FIG. 3 represents insertion of the virtual card 304 by swiping the virtual card 304 towards the virtual card slot 302. In an exemplary e embodiment, FIG. 3 represents the virtual card swipe direction 306 which is in upward direction. In an exemplary embodiment, the virtual card swipe direction can be represented by 306 which shows in an exemplary embodiment, the virtual card swipe direction 306 can be downward direction in case if the virtual card slot is in bottom side and the virtual card is in top side.

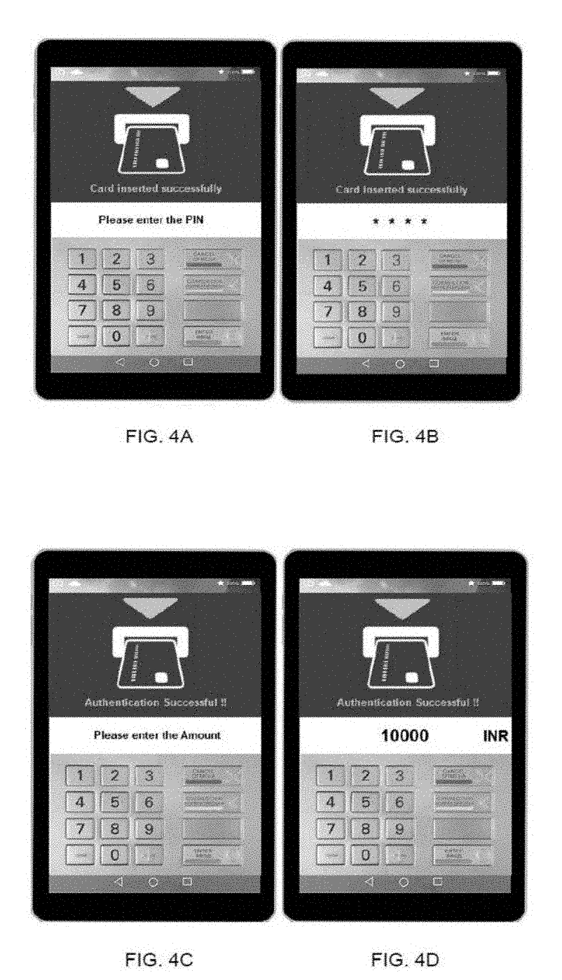

FIGS. 4A-4D illustrates a virtual transaction using swipe with general POS machine, in accordance with an exemplary embodiment of the present disclosure. In an exemplary embodiment, after completion of the first step i.e. once the card image is inserted into the POS image space, then the POS application communicates with the actual POS machine which is paired with the mobile device. POS mobile application can capture all the details from the card and send to the POS machine. Now POS machine connects with bank server and validate the card details. Once the validation and verification is done and succeeded then the POS send instruction to the POS app to enter the PIN. Now customer enters the PIN from his/her mobile device. In an implementation, a third level of authentication i.e., to enter the OTP to complete the transaction may also be implemented as an additional security.

FIG. 4A illustrates the interface/display of the mobile device to prompt the customer to enter the PIN based upon the validation and verification of the card details. In an exemplary embodiment, the system or bank server can prompt the customer to enter the PIN. In another exemplary embodiment, the PIN can be pre-defined/pre-configured by the user while registration of the bank account. In an exemplary embodiment, the customer can enter the PIN which is pre-defined/pre-configured by the user while bank account opening. FIG. 4B illustrates the interface/display which shows the PIN entered by the user/customer.

FIG. 4C illustrates the interface/display of the mobile device to prompt the customer to enter an amount based upon authentication of the PIN entered by the user/customer. In an exemplary embodiment, the system or bank server can validate/verify/authenticate the PIN entered by the user customer. In an exemplary embodiment, the customer can enter the amount. FIG. 4D illustrates the interface/display which shows the amount entered by the user/customer which user/customer wish to transfer/pay to merchant's account. In another exemplary embodiment, OTP authentication can be added to this system after amount entered.

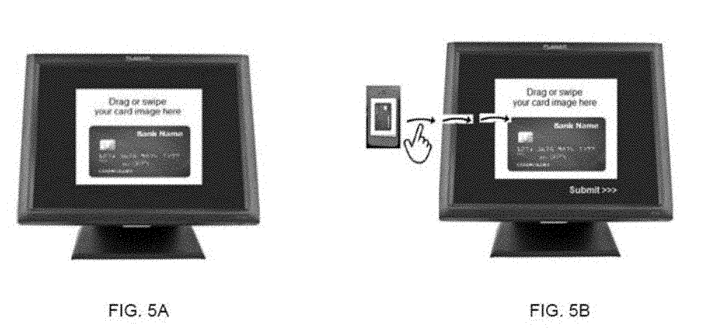

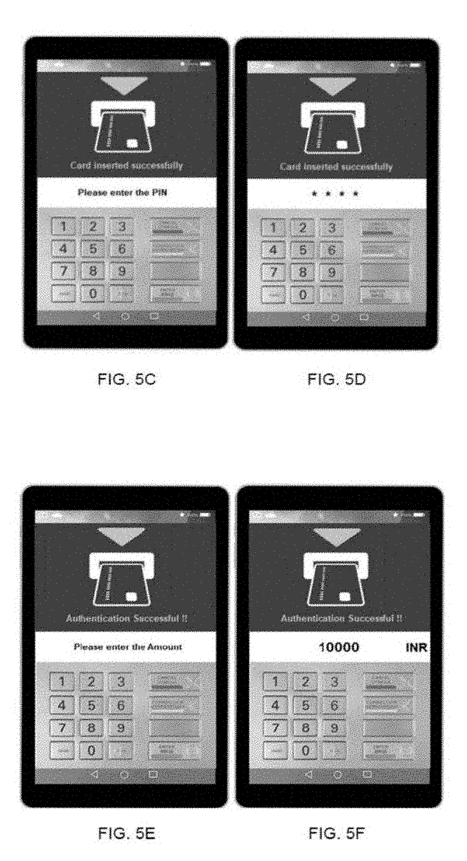

FIG. 5A-5F illustrates a virtual transaction using vswipe with integrated POS monitor, in accordance with an exemplary embodiment of the present disclosure. In an embodiment, FIG. 5B represents a step where the customer/user can swipe/drag virtual card (virtual card image or card image) through a portable device such as mobile device or computing device of the user to an integrated POS monitor. In an exemplary embodiment, the customer/user needs to drag their virtual card or virtual card image (present in mobile device) towards the POS monitor. In an exemplary embodiment, the POS monitor and Mobile device can be connected with each other by spatial connection as the POS monitor or mobile device can be equipped with spatially aware sensors. In an exemplary embodiment, as the virtual card drag/swipe towards the integrated POS monitor then the POS monitor can connect with a bank server and validate the card details.

FIG. 5C illustrates interface/display of the mobile device to prompt the customer to enter the PIN based upon the validation and verification of the card details. In an exemplary embodiment, the system or bank server can prompt the customer to enter the PIN. In another exemplary embodiment, the PIN can be pre-defined/pre-configured by the user while registration of the bank account. In an exemplary embodiment, the customer can enter the PIN which is pre-defined/pre-configured by the user while bank account opening. FIG. 5D illustrates the interface/display which shows the PIN entered by the user/customer.

FIG. 5E illustrates the interface/display of the mobile device to prompt the customer to enter an amount based upon authentication of the PIN entered by the user/customer. In an exemplary embodiment, the system or bank server can validate/verify/authenticate the PIN entered by the user/customer. In an exemplary embodiment, the customer can enter the amount. FIG. 5F illustrates the interface/display which shows the amount entered by the user/customer which user/customer wants to transfer/pay to merchant's account. In another exemplary embodiment, OTP authentication can be added to this system after amount entered.

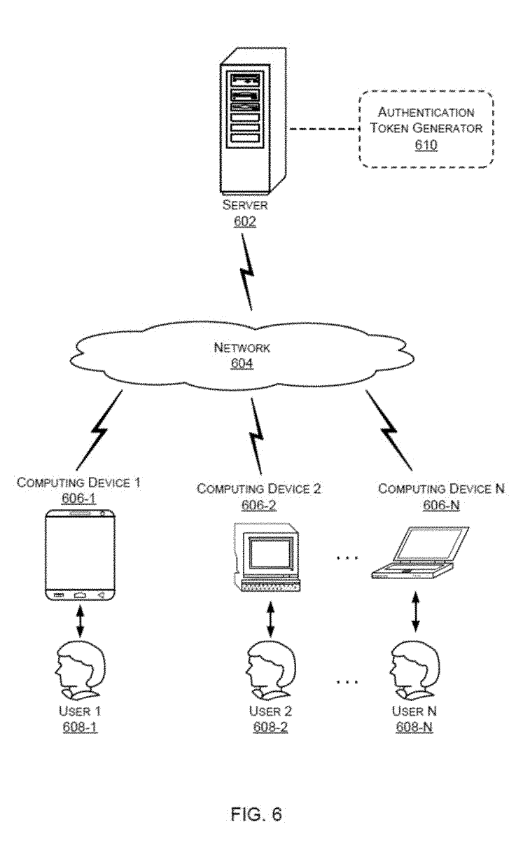

FIG. 6 illustrates a network implementation of a proposed electronic device (also hereinafter interchangeably referred to as “authentication token generator”), in accordance with an exemplary embodiment of the present disclosure.

Referring now to FIG. 6, in an embodiment, FIG. 6 indicates a network implementation of a proposed authentication token generator 610. Although the present subject matter is explained considering that the proposed authentication token generator 610 is implemented as an application on a server 602, it may be understood that the proposed authentication token generator 610 may also be implemented in a variety of computing systems, such as a laptop computer, a desktop computer, a notebook, a workstation, a server, a network server, a cloud-based environment and the like. It would be appreciated that the proposed authentication token generator 610 may be accessed by multiple users 608-1, 608-2 . . . 608-N (collectively referred to as users 608., and individually referred to as the user 608 hereinafter), through one or more computing devices 606-1, 606-2 . . . 606-N (collectively referred to as computing devices 606 hereinafter), or applications residing on the computing devices 606. In an aspect, the proposed authentication token generator 610 can be operatively coupled to a website and so be operable from any Internet enabled computing device 606. Examples of the computing devices 606 may include, but are not limited to, a portable computer, a personal digital assistant, a handheld device, and a workstation. The computing devices 606 are communicatively coupled to the proposed authentication token generator 610 through a network 604.

In one implementation, the network 604 can be a wireless network, a wired network or a combination thereof. The network 604 can be implemented as one of the different types of networks, such as intranet, local area network (LAN wide area network (WAN), the internet, and the like. Further, the network 604 may either be a dedicated network or a shared network. The shared network represents an association of the different types of networks that use a variety of protocols, for example, Hypertext Transfer Protocol (HTTP). Transmission Control Protocol/Internet Protocol (TCP/IP), Wireless Application Protocol (WAP), and the like, to communicate with one another. Further the network 104 can include a variety of network devices, including routers, bridges, servers, computing devices, storage devices, and the like.

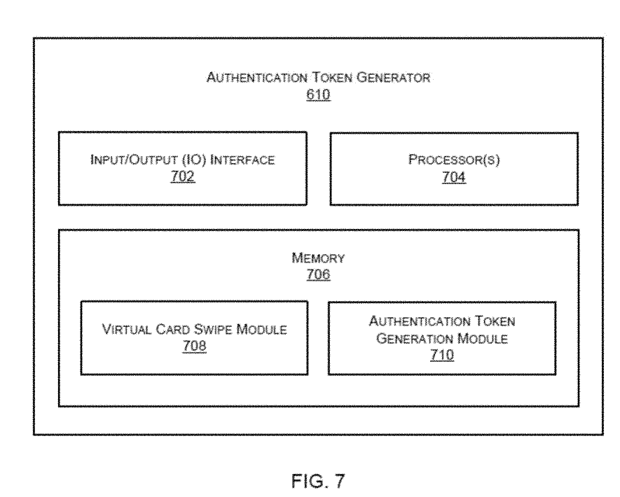

FIG. 7 illustrates exemplary functional modules of the proposed authentication token generator 610, in accordance with an exemplary embodiment of the present disclosure. In one embodiment, the proposed authentication token generator 610 may include at least one processor 702, an input/output (I/O) interface 704, and a memory 706. The at least one processor 702 may be implemented as one or more microprocessors, microcomputers, microcontrollers, digital signal processors, central processing units, state machines, logic circuitries, and/or any devices that manipulate signals based on operational instructions. Among other capabilities, the at least one processor 702 is configured to fetch and execute computer-readable instructions stored in the memory 706.

The I/O interface 704 may include a variety of software and hardware interfaces, for example, a web interface, a graphical user interface, and the like. The I/O interface 704 may allow the proposed authentication token generator 610 to interact with a user directly or through the client devices 704. Further, the I/O interface 704 may enable the proposed authentication token generator 610 to communicate with other computing devices, such as web servers and external data servers (not shown). The I/O interface 704 can facilitate multiple communications within a wide variety of networks and protocol types, including wired networks, for example, LAN, cable, etc., and wireless networks, such as WLAN, cellular, or satellite. The I/O interface 704 may include one or more ports for connecting a number of devices to one another or to another server.

The memory 706 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 706 may include modules, routines, programs, objects, components, data structures, etc., which perform particular tasks or implement particular abstract data types. In one implementation, the memory 706 may include a virtual card swipe module 708 and an authentication token generation module 710.

In an exemplary embodiment, a proposed authentication token generator 610 can includes a non-transitory storage device having embodied therein one or more routines, and one or more processors coupled to the non-transitory storage device and operable to execute the one or more routines. The one or more routines include the virtual card swipe module 708 that enables a user to virtually swipe said at least one virtual card selected from said one or more virtual cards towards a virtual card slot presented on an interface of the electronic device, and an authentication token generation module 720 generates and/or presents said at least an authentication token to perform at least one physical transaction.

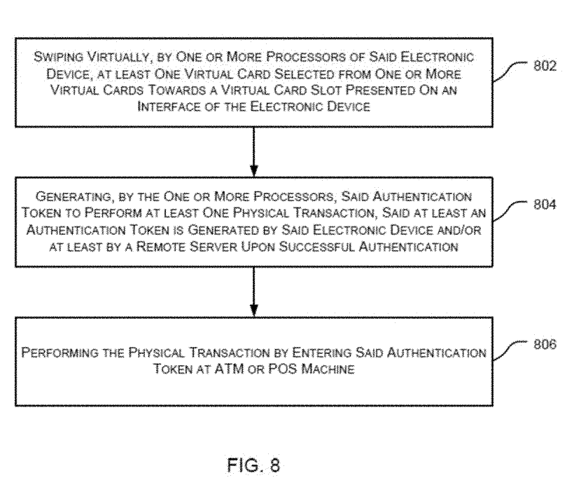

FIG. 8 illustrates an exemplary flow diagram representing method performed by the proposed authentication token generator, in accordance with an exemplary embodiment of the present disclosure. The method may be described in the general context of computer executable instructions. Generally, computer executable instructions can include routines, programs, objects, components, data structures, procedures, modules, functions, etc., that perform particular functions or implement particular abstract data types. The method 600 may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above proposed authentication token generator 610.

At block 802, at least one virtual card selected from one or more virtual cards is swiped virtually towards a virtual card slot presented on an interface of the electronic device. In an exemplary embodiment, said one or more virtual cards are pre-stored in memory of said electronic device and retrieved from the memory while swiping.

At block 804, an authentication token is generated to perform at least one physical transaction, said at least an authentication token is generated by said electronic device and/or at least by a remote server upon successful authentication.

At block 806, a transaction is performed by the user by physically entering the authentication token number at physical ATM or POS machines.

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. As shown in the figure, computer system includes an external storage device, a bus, a main memory, a read only memory, a mass storage device, communication port, and a processor. A person skilled in the art will appreciate that computer system may include more than one processor and communication ports. Examples of processor include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor may include various modules associated with embodiments of the present invention. Communication port can be any of an RS-232 port for use with a modem based dialup connection, a 10/100 Ethernet port, a Gigabit or 10 Gigabit port using copper or fiber, a serial port, a parallel port, or other existing or future ports. Communication port 660 may be chosen depending on a network, such a Local Area Network (LAN), Wide Area Network (WAN), or any network to which computer system connects. Memory can be Random Access Memory (RAM), or any other dynamic storage device commonly known in the art. Read only memory can be any static storage device(s) e.g., but not limited to, a Programmable Read Only Memory (PROM) chips for storing static information e,g., start-up or BIOS instructions for processor. Mass storage may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc. Bus communicatively couples processor(s) with the other memory, storage and communication blocks. Bus can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor to software system. Optionally, operator and administrative interfaces, e.g. a display, keyboard, and a cursor control device, may also be coupled to bus to support direct operator interaction with computer system. Other operator and administrative interfaces can be provided through network connections connected through communication port. External storage device can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

The various illustrative logical blocks, modules and circuits and algorithm steps described herein may be implemented or performed as electronic hardware, software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. It is noted that the configurations may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method a function, a procedure a subroutine, a subprogram, etc. When a process corresponds to a function, its termination corresponds to return of the function to the calling function or the main function.

When implemented in hardware, various examples may employ a general purpose processor, a digital signal processor (DSP), an application specific integrated circuit (ASIC), a field programmable gate array signal (FPGA) or other programmable logic device, discrete g,ate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

When implemented in software, various examples may employ firmware, middleware or microcode. The program code or code segments to perform the necessary tasks may be stored in a computer-readable medium or processor-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the terms “component,” “module” “system,” and the like tare intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In one or more examples herein, the functions described may be implemented in hardware, software, firmware, or any combination thereof. If implemented in software, the functions may be stored on or transmitted over as one or more instructions or code on a computer-readable medium or processor-readable medium. A processor-readable media and/or computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium or processor-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium, Disk and disc, as used herein, includes compact disc (CD), laser disc, optical disc, digital versatile disc (DVD), floppy disk and blue-ray disc where disks usually reproduce data magnetically, while discs reproduce data optically with lasers. Combinations of the above should also be included within the scope of computer-readable media. Software may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

One or more of the components, steps, and/or functions illustrated in the Figures may be rearranged and/or combined into a single component, step, or function or embodied in several components, steps, or functions. Additional elements, components, steps, and/for functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

1. An electronic device, comprising:
a non-transitory storage device having embodied therein one or more routines operable to generate at least an authentication token to perform at least one physical transaction; and
one or more processors coupled to the non-transitory storage device and operable to execute the one or more routines, wherein the one or more routines include:
a virtual card swipe module, which when executed by the one or more processors, enables a user to virtually swipe said at least one virtual card selected from said one or more virtual cards towards a virtual card slot presented on an interface of the electronic device, wherein said one or more virtual cards are pre-stored in said non-transitory storage device;
an authentication token generation module, which when executed by the one or more processors, generates and/or presents said at least an authentication token to perform at least one physical transaction.

2. The electronic device of claim 1, wherein said one or more virtual cards are associated with one or more similar or different financial institution.

3. The electronic device of claim 1, wherein said virtual card slot is provided by at least one application program installed on the electronic device or at least by a remote server.

4. The electronic device of claim 1, wherein said at least an authentication token is generated by said electronic device and/or at least by a remote server, wherein said authentication token is generated upon successful authentication of said at least one virtual card virtually swiped in said virtual card slot.

5. The electronic device of claim 4, wherein said at least one virtual card swiped virtually in said virtual card slot is authenticated by fetching at least an account detail associated with said at least one virtual card and comparing said account detail fetched with one or more account details pre-stored in said electronic device and/or at least by a remote server.

6. The electronic device of claim 1, wherein said at least an authentication token is generated upon providing at least a security number or a personal identification number (PIN) associated with the said at least one virtual card swiped virtually in said virtual card slot. wherein said security number or said personal identification number is authenticated by comparison with one or more account details pre-stored in said electronic device and/or at least by a remote server.

7. The electronic device of claim 1, wherein said electronic device is configured to be paired/communicatively coupled with one or more computing devices, wherein said computing devices, upon pairing, are configured to provide said virtual card slot on the interface of said electronic device.

8. A system to generate at least an authentication token to perform at least one physical transaction, said system comprising:
an electronic device as claimed in claims 1-6, and
at least one remote server configure to:
fetch at least an account detail associated with said at least one virtual card swiped virtually in said virtual card slot; or
receive at least a security number or a personal identification number (PIN); and
compare said account detail fetched or said security number or said personal identification number with one or more account details pre-stored for generation of said at least an authentication token to perform at least one physical transaction upon authentication.

9. A method for generating at least an authentication token to perform at least one physical transaction using a electronic device, said method comprising:
swiping virtually, by one or more processors of said electronic device, at least one virtual card selected from one or more virtual cards towards a virtual card slot presented on an interface of the electronic device, wherein said one or more virtual cards are pre-stored in memory of said electronic device and retrieved from the memory while swiping;
generating, by the one or more processors, said authentication token to perform at least one physical transaction, said at least an authentication token is generated by said electronic device and/or at least by a remote server upon successful authentication.

10. The method claim of 9, wherein said authentication is performed by:
fetching at least an account detail associated with said at least one virtual card and comparing said account detail fetched with one or more account details pre-stored in said electronic device and/or at least by a remote server.
